(19) United States
(12) Patent Application Publication
(10) Pub. No.: US 2016/0321917 A1
(43) Pub. Date: Nov. 3, 2016

(54) UTILIZING A MOBILE DEVICE AS A MOTION-BASED CONTROLLER

(71) Applicant: Board of Regents, The University of Texas System, Austin, TX (US)

(72) Inventors: Lili Qiu, Austin, TX (US); Sangki Yun, Austin, TX (US); Yi-Chao Chen, Austin, TX (US)

(21) Appl. No.: 15/135,877

(22) Filed: Apr. 22, 2016

Related U.S. Application Data
(60) Provisional application No. 62/154,809, filed on Apr. 30, 2015.

(51) Int. Cl. G08C 23/02; G06F 3/038; G06F 3/0346; H04W 4/02; G01S 15/08

(52) U.S. Cl. CPC G08C 23/02; H04W 4/023; G01S 15/08; G06F 3/0346; G06F 3/0383; H04W 88/02

(57) ABSTRACT

A method, system and computer program product for accurately tracking the position of a mobile device. The microphone on a mobile device receives acoustic signals at a few selected frequencies from a device to be controlled by the mobile device. The frequency shifts are used to estimate the speed and distance traveled. The distance between the speakers of the device to be controlled is calibrated and the mobile device's initial position is narrowed down using its movement trajectory. Based on the information, the mobile device's new position is continuously tracked in real time. Hence, movement of the mobile device can be accurately tracked, thereby allowing the mobile device to be realized as a motion-based controller (e.g., mouse, game controller, controller for Internet of Things).

### CROSS REFERENCE TO RELATED APPLICATIONS

This application is related to the following commonly owned co-pending U.S. patent application:

Provisional Application Ser. No. 62/154,809, “Utilizing a Mobile Device as a Mouse,” filed Apr. 30, 2015, and claims the benefit of its earlier filing date under 35 U.S.C. §119(e).

### TECHNICAL FIELD

The present invention relates generally to pointing devices, such as a mouse, and more particularly to utilizing a mobile device as a motion-based controller (e.g., mouse, game controller, controller for Internet of Things).

### BACKGROUND

In computing, a mouse is a pointing device that detects two-dimensional motions relative to a surface. This motion is typically translated into the motion of a pointer on a display, which allows for fine control of a graphical user interface.

Physically, a mouse consists of an object held in one's hand, with one or more buttons. Mice often feature other elements, such as touch surfaces and “wheels,” which enable additional control and dimensional input.

The mouse has been one of the most successful technologies for controlling the graphic user interface due to its ease of use. Its attraction will soon penetrate well beyond just computers. There already have been mice designed for game consoles and smart TVs. A smart TV allows a user to run popular computer programs and smartphone applications. For example, a smart TV user may want to use a web browser and click on a certain URL or some part of a map using a mouse. A traditional remote controller, which uses buttons for user input, is no longer sufficient to exploit the full functionalities offered by the smart TV. More and more devices in the future, such as smartglasses (e.g., Google Glasses®), baby monitors, and a new generation of home appliances, will all desire mouse functionalities, which allow users to choose from a wide variety of options and easily click on different parts of the view.

On the other hand, a traditional mouse, which requires a flat and smooth surface to operate, cannot satisfy many new usage scenarios. A user may want to interact with the remote device while on the move. For example, a speaker wants to freely move around and click on different objects in his slide; a smart TV user wants to watch TV in any part of a room; a Google Glass® user wants to query about objects while he is touring around. It would certainly be nice if a user could simply turn his/her mobile device (e.g., smartphone, smart watch) into a mouse by moving it in the air.

### SUMMARY

In one embodiment of the present invention, a method for utilizing a mobile device as a motion-based controller comprises determining a distance between two or more speakers of a device to be controlled by the mobile device. The method further comprises receiving inaudible acoustic signals by the mobile device with a microphone from the device. The method additionally comprises recording the inaudible acoustic signals. Furthermore, the method comprises estimating a frequency shift using the recorded inaudible acoustic signals. Additionally, the method comprises estimating a velocity of the mobile device using the estimated frequency shift. In addition, the method comprises estimating distances the mobile device is located from each of the two or more speakers using the estimated velocity and a previous position of the mobile device. The method further comprises determining, by a processor, a current location of the mobile device using the estimated distances the mobile device is located from the two or more speakers, the distance between the two or more speakers of the device and the previous position of the mobile device.

Other forms of the embodiment of the method described above are in a system and in a computer program product.

In another embodiment of the present invention, a method for utilizing a mobile device as a motion-based controller comprises determining a distance between a speaker and a wireless transmitter of a wireless device. The method further comprises receiving an inaudible acoustic signal by the mobile device with a microphone from a device with the speaker to be controlled by the mobile device. The method additionally comprises receiving a radio frequency signal from the wireless device. Furthermore, the method comprises recording the inaudible acoustic signal and the radio frequency signal. Additionally, the method comprises estimating a phase of the radio frequency signal. In addition, the method comprises estimating a distance the mobile device is located from the wireless transmitter using the estimated phase of the radio frequency signal and a previous position of the mobile device. The method further comprises estimating a frequency shift using the recorded inaudible acoustic signal. The method additionally comprises estimating a velocity of the mobile device from the speaker using the estimated frequency shift. Furthermore, the method comprises estimating a distance the mobile device is located from the speaker using the estimated velocity and the previous position of the mobile device.

Additionally, the method comprises determining, by a processor, a current location of the mobile device using the estimated distance the mobile device is located from the speaker, the estimated distance the mobile device is located from the wireless transmitter, the distance between the speaker and the wireless transmitter of the wireless device and the previous position of the mobile device.

Other forms of the embodiment of the method described above are in a system and in a computer program product.

In a further embodiment of the present invention, a method for utilizing a mobile device as a motion-based controller comprises determining a distance between two or more speakers of a device to be controlled by the mobile device. The method further comprises determining a distance between each of the two or more speakers of the device and a wireless transmitter of a wireless device. The method additionally comprises receiving inaudible acoustic signals by the mobile device with a microphone from the device. Furthermore, the method comprises receiving a radio frequency signal from the wireless device. Additionally, the method comprises recording the inaudible acoustic signals and the radio frequency signal. In addition, the method comprises estimating a phase of the radio frequency signal. The method further comprises estimating a distance the mobile device is located from the wireless transmitter of the wireless device using the estimated phase of the radio frequency signal and a previous position of the mobile device. The method additionally comprises estimating a frequency shift using the recorded inaudible acoustic signals. Furthermore, the method comprises estimating a velocity of the mobile device towards each of the two or more speakers using the estimated frequency shift. Additionally, the method comprises estimating distances the mobile device is located from each of the two or more speakers using the estimated velocity and the previous position of the mobile device. In addition, the method comprises determining, by a processor, a current location of the mobile device using the estimated distances the mobile device is located from each of the two or more speakers, the estimated distance the mobile device is located from the wireless transmitter of the wireless device, the distance between the two or more speakers of the device, the distance between each of the two or more speakers of the device and the wireless transmitter of the wireless device and the previous position of the mobile device.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a system configured in accordance with an embodiment of the present invention;

FIG. 2 illustrates a hardware configuration of a mobile device in accordance with an embodiment of the present invention;

FIG. 3 is a flowchart of a method for utilizing the mobile device as a motion-based controller (e.g., mouse) to communicate with an electronic device in accordance with an embodiment of the present invention;

FIG. 4A illustrates a user scanning a device with the user's hand holding the mobile device during the calibration process in accordance with an embodiment of the present invention;

FIG. 4B shows the change of the Doppler shift while a user is performing the calibration in accordance with an embodiment of the present invention;

FIGS. 5A and 5B show the Doppler shift and the moving distance over time estimated by Equation EQ1, respectively, in accordance with an embodiment of the present invention;

FIGS. 6A and 6B show an example of the received audio signal in the frequency domain and the estimated Doppler shift, respectively, while the mobile device is moving around a circle in accordance with an embodiment of the present invention;

FIG. 7 illustrates that the new position should be the intersection of the two circles whose center points are (0, 0) and (D, 0), and radii are D_{1,1} and D_{1,2}, respectively, in accordance with an embodiment of the present invention;

FIGS. 8A-8C show the raw Doppler shift measurements and the result after Maximal Ratio Combining (MRC) without and with outlier removal, respectively, in accordance with an embodiment of the present invention; and

FIG. 9 is a flowchart of a method for controlling an electronic device containing a single speaker in accordance with an embodiment of the present invention.

### DETAILED DESCRIPTION

While the following discusses the present invention in connection with utilizing a mobile device as a motion-based controller, such as a mouse, using an electronic device (e.g., smart TV) with two speakers or an electronic device with a single speaker plus one wireless device, the principles of the present invention may be applied to devices with three or more speakers with or without utilizing the wireless device. For example, if more than two speakers are available, the mobile device can be tracked in a higher dimension and/or the accuracy can be improved. More specifically, the distance from each speaker can be derived in the same manner as discussed herein, and then apply the intersections of these circles. For example, if the electronic device has three speakers, then localization can occur in a 3-D space by intersecting three circles. If one is interested in only the 2-D space, then the distance from the additional speaker can be used to improve accuracy (e.g., the location is estimated as the centroids of these intersections). A person of ordinary skill in the art would be capable of applying the principles of the present invention to such implementations. Further, embodiments applying the principles of the present invention to such implementations would fall within the scope of the present invention.

In the following description, various embodiments are described. For purposes of explanation, specific configurations and details are set forth in order to provide a thorough understanding of the embodiments. It will also be apparent to one skilled in the art that the present invention can be practiced without the specific details described herein. Furthermore, well-known features may be omitted or simplified in order not to obscure the embodiment being described.

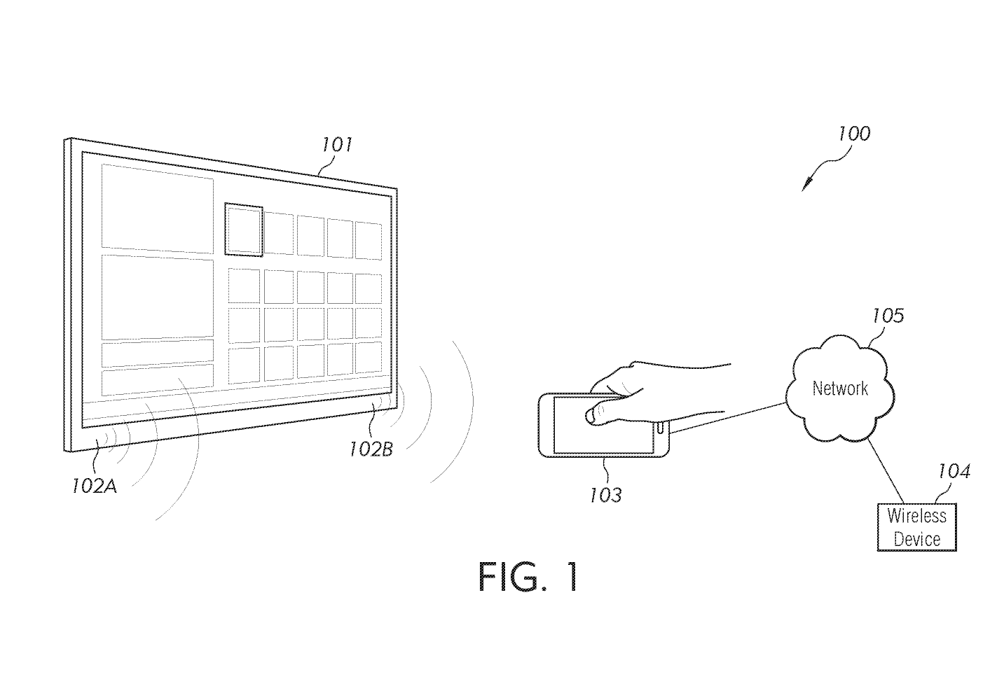

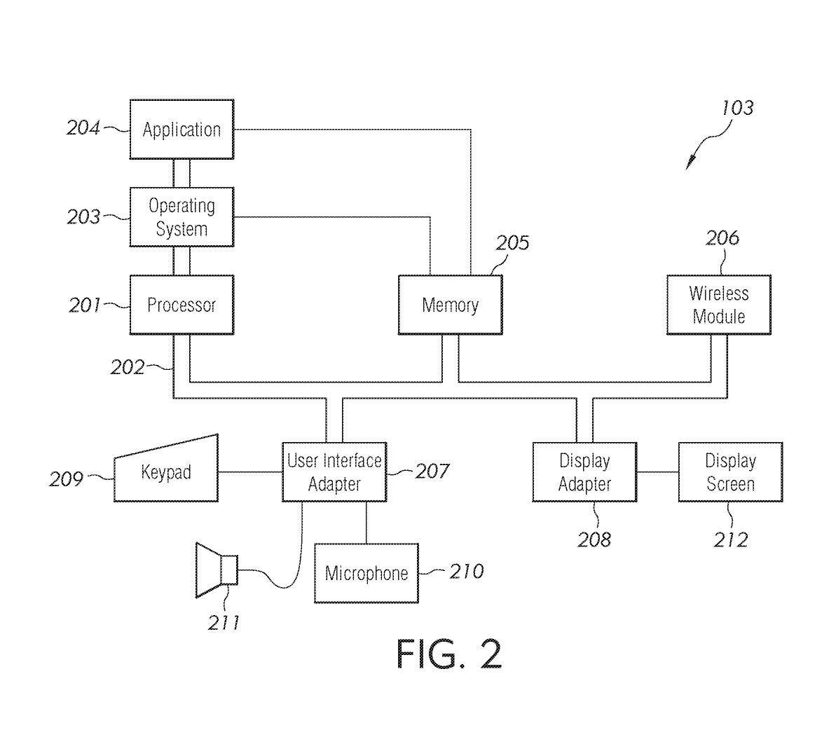

Referring now to the Figures in detail, FIG. 1 illustrates a system 100 configured in accordance with an embodiment of the present invention. Referring to FIG. 1, system 100 includes an electronic device 101 (e.g., smart TV, laptop, desktop computer system) with two or more speakers 102A-102B that can be controlled by a mobile device 103. While the following discusses device 101 as containing two speakers 102A-102B, device 101 may contain either a single speaker or more than three speakers as discussed further below. System 100 may optionally include a wireless device 104 in communication with mobile device 103 over a network 105. Mobile device 103 may be a portable computing unit, a Personal Digital Assistant (PDA), a smartphone, a mobile phone, a navigation device, a game console and the like. Mobile device 103 may be any mobile computing device with a microphone. A description of the hardware configuration of mobile device 103 is provided below in connection with FIG. 2. Wireless device 104 may be a Wi-Fi card, a Bluetooth card or other wireless transmitter.

Network 105 may be, for example, a Bluetooth network, a Wi-Fi network, an IEEE 802.11 standards network, various combinations thereof, etc. Other networks, whose descriptions are omitted here for brevity, may also be used in conjunction with system 100 of FIG. 1 without departing from the scope of the present invention.

System 100 is not to be limited in scope to any one particular network architecture.

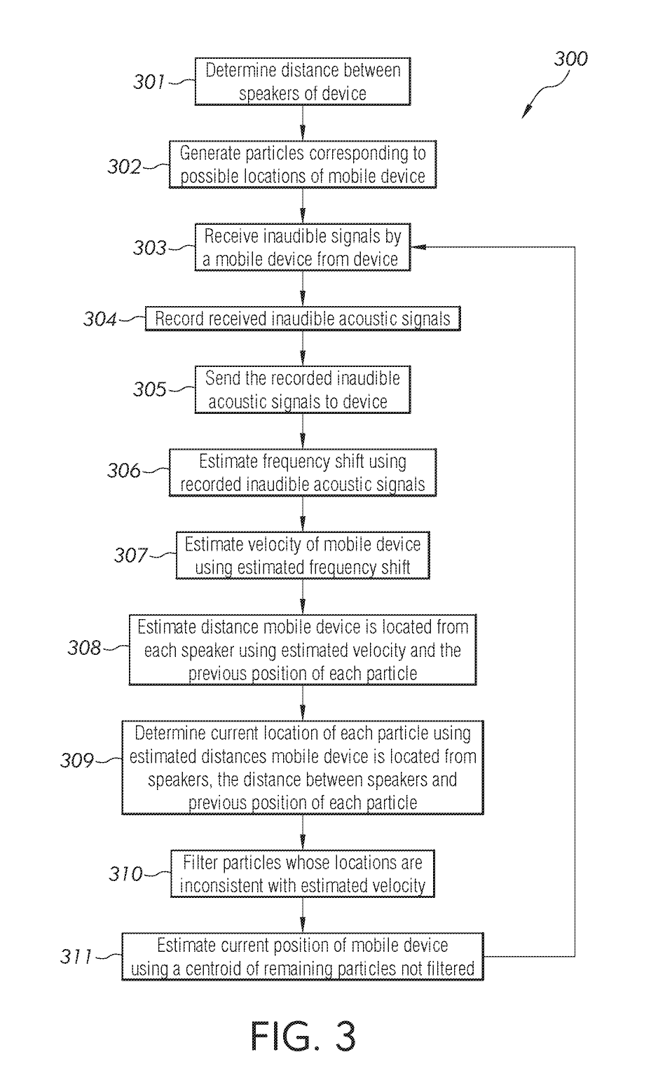

Referring now to FIG. 2, FIG. 2 illustrates a hardware configuration of mobile device 103 (FIG. 1) which is representative of a hardware environment for practicing the present invention. Referring to FIG. 2, mobile device 103 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for utilizing mobile device 103 as a motion-based controller (e.g., mouse, game controller, controller for Internet of Things) as discussed further below in association with FIGS. 3, 4A-4B, 5A-5B, 6A-6B, 7, 8A-8C and 9.

Mobile device 103 further includes a memory 205 connected to bus 202 that is configured to control the other functions of mobile device 103. Memory 205 is generally integrated as part of the mobile device 103 circuitry, but may, in some embodiments, include a removable memory, such as a removable disk memory, integrated circuit (IC) memory, a memory card, or the like. Processor 201 and memory 205 also implement the logic and store the settings, preferences and parameters for mobile device 103. It should be noted that software components including operating system 203 and application 204 may be loaded into memory 205, which may be mobile device's 103 main memory for execution.

Mobile device 103 additionally includes a wireless module 206 that interconnects bus 202 with an outside network (e.g., network 105 of FIG. 1) thereby allowing mobile device 103 to communicate with other devices, such as wireless device 104 (FIG. 1). In one embodiment, wireless module 206 includes local circuitry configured to wirelessly send and receive short range signals, such as Bluetooth, infrared or Wi-Fi.

I/O devices may also be connected to mobile device 103 via a user interface adapter 207 and a display adapter 208. Keypad 209, microphone 210 and speaker 211 may all be interconnected to bus 202 through user interface adapter 207. Keypad 209 is configured as part of mobile device 103 for dialing telephone numbers and entering data. Mobile device 103 may have microphone 210 and speaker 211 for the user to speak and listen to callers. Additionally, mobile device 103 includes a display screen 212 connected to system bus 202 by display adapter 208. Display screen 212 may be configured to display messages and information about incoming calls or other features of mobile device 103 that use a graphic display. In this manner, a user is capable of inputting to mobile device 103 through keypad 209 or microphone 210 and receiving output from mobile device 103 via speaker 211 or display screen 212. Other input mechanisms may be used to input data to mobile device 103 that are not shown in FIG. 2, such as display screen 212 having touch-screen capability with the ability to utilize a virtual keyword. Mobile device 103 of FIG. 2 is not to be limited in scope to the elements depicted in FIG. 2 and may include fewer or additional elements than depicted in FIG. 2. For example, mobile device 103 may only include memory 205, processor 201, microphone 210 and wireless module 206.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, the mouse has been one of the most successful technologies for controlling the graphic user interface due to its ease of use. Its attraction will soon penetrate well beyond just computers. There already have been mice designed for game consoles and smart TVs. A smart TV allows a user to run popular computer programs and smartphone applications. For example, a smart TV user may want to use a web browser and click on a certain URL or some part of a map using a mouse. A traditional remote controller, which uses buttons for user input, is no longer sufficient to exploit the full functionalities offered by the smart TV. More and more devices in the future, such as Google Glass®, baby monitors, and a new generation of home appliances, will all desire mouse functionalities, which allow users to choose from a wide variety of options and easily click on different parts of the view. On the other hand, a traditional mouse, which requires a flat and smooth surface to operate, cannot satisfy many new usage scenarios. A user may want to interact with the remote device while on the move. For example, a speaker wants to freely move around and click on different objects in his slide; a smart TV user wants to watch TV in any part of a room; a Google Glass® user wants to query about objects while he is touring around. It would certainly be nice if a user could simply turn his/her mobile device (e.g., smartphone, smart watch) into a mouse by moving it in the air.

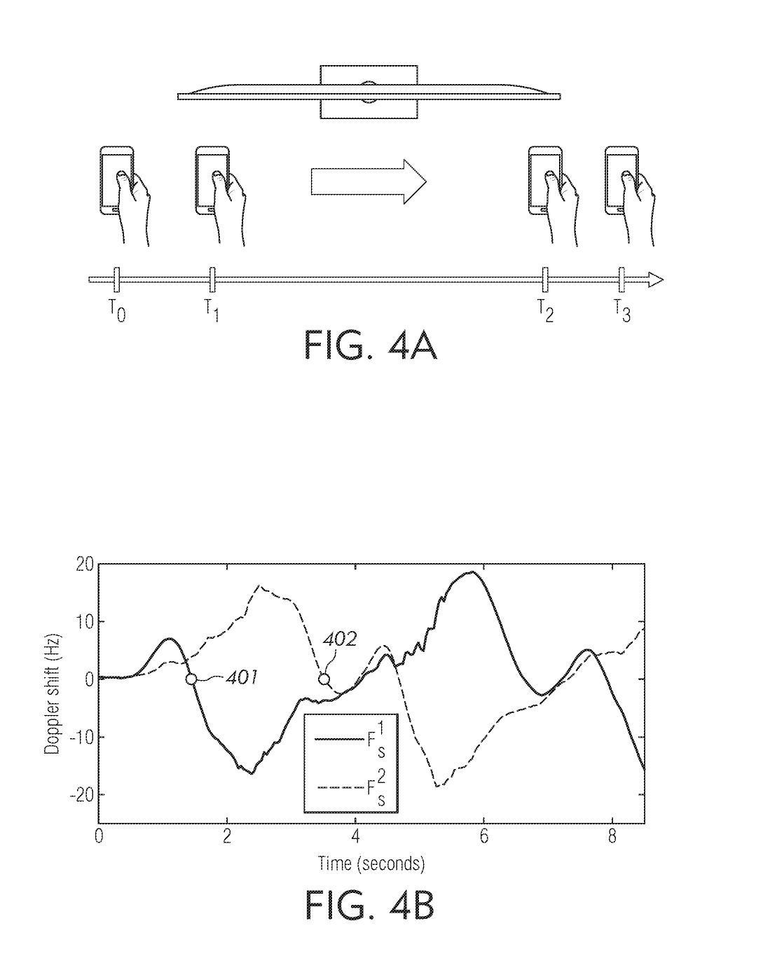

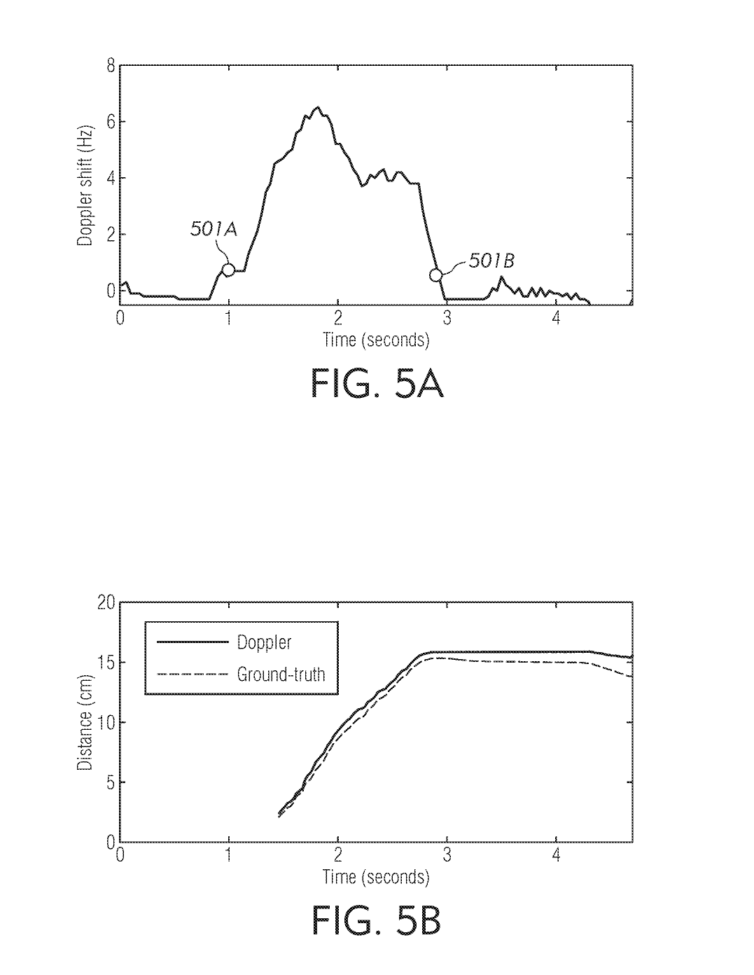

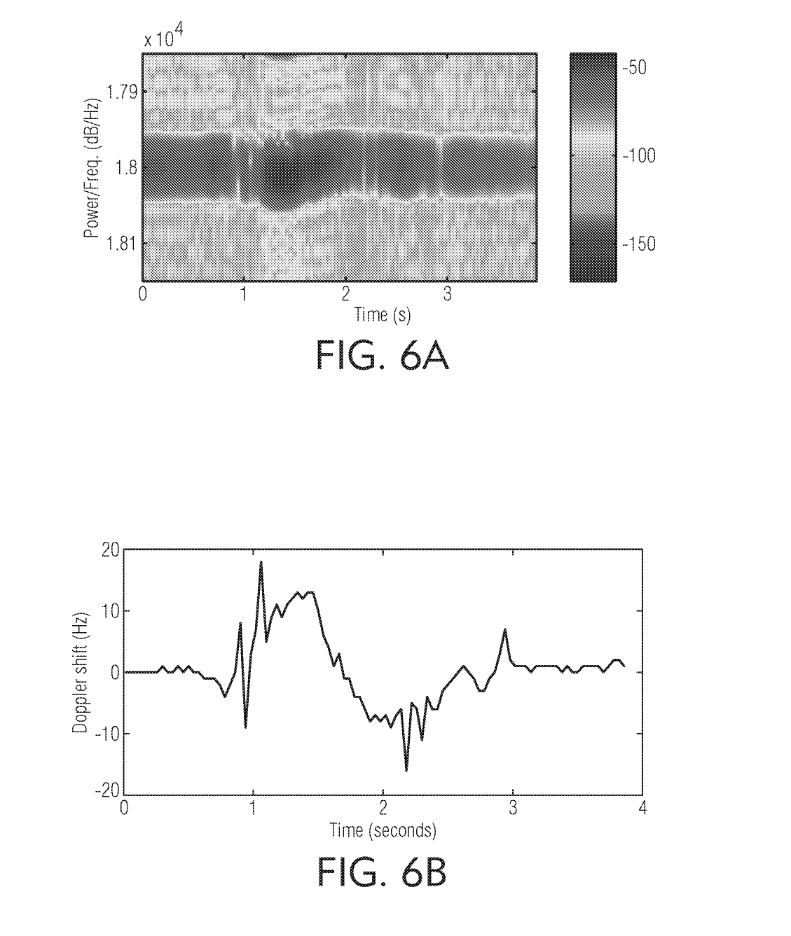

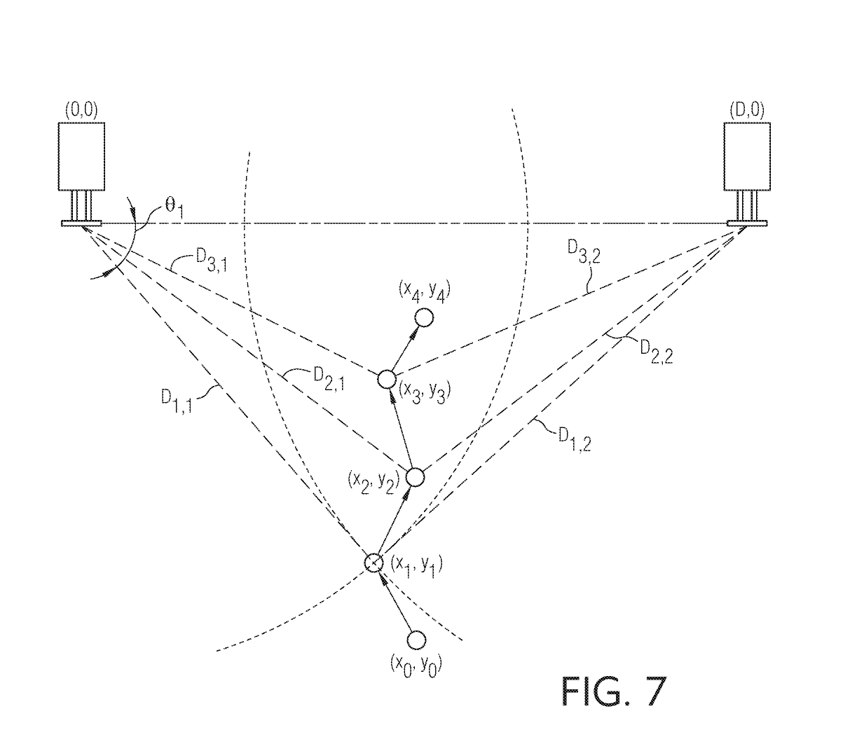

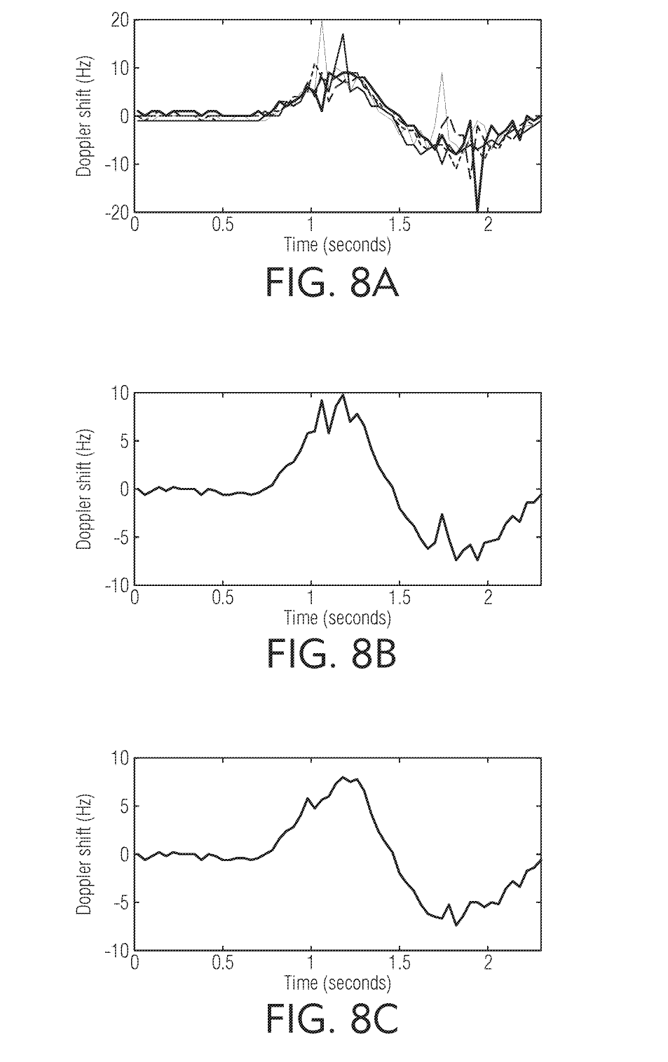

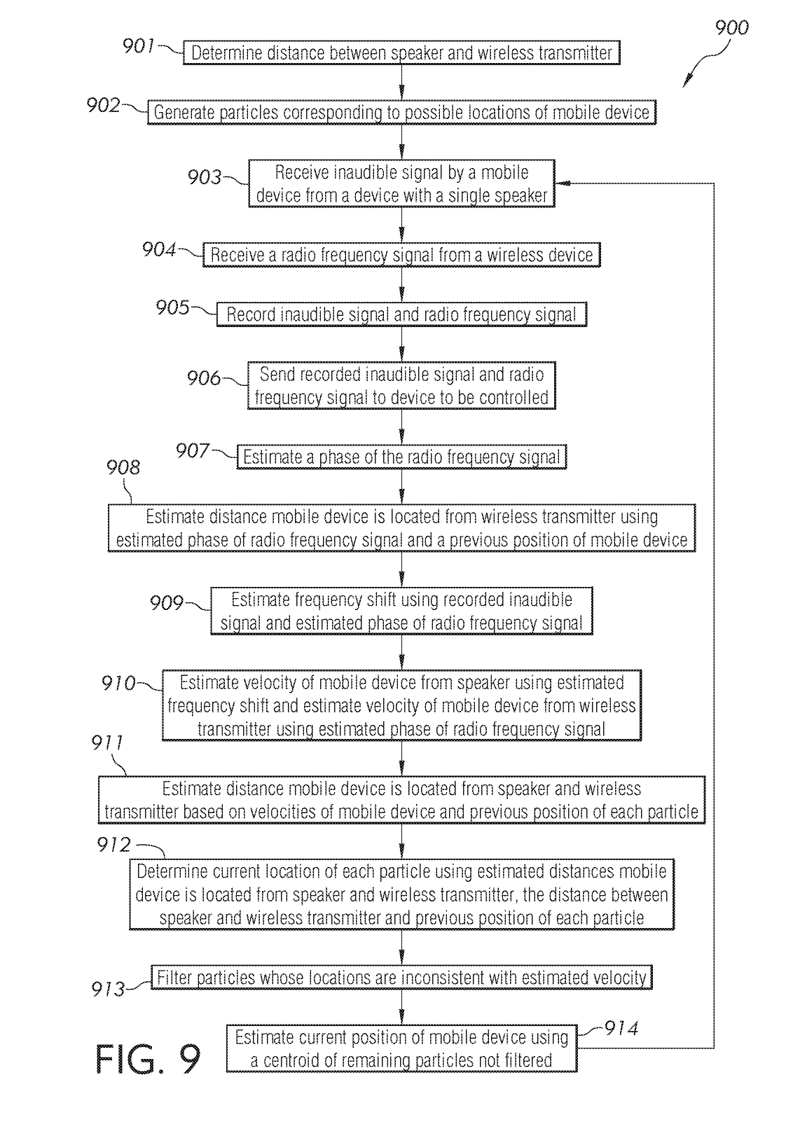

The principles of the present invention provide a means for enabling mobile devices, such as smartphones, to be utilized as a motion-based controller (e.g., mouse, game controller, controller for Internet of Things) in communicating with devices, such as smart TVs, as discussed below in association with FIGS. 3, 4A-4B, 5A-5B, 6A-6B, 7, 8A-8C and 9. FIG. 3 is a flowchart of a method for utilizing mobile device 103 (FIGS. 1 and 2) as a motion-based controller (e.g., mouse, game controller, controller for Internet of Things). FIG. 4A illustrates a user scanning a device with the user's hand holding the mobile device during the calibration process. FIG. 4B shows the change of the Doppler shift while a user is performing the calibration. FIGS. 5A and 5B show the Doppler shift and the moving distance over time estimated by Equation EQ1, respectively. FIGS. 6A and 6B show an example of the received audio signal in the frequency domain and the estimated Doppler shift, respectively, while the mobile device is moving around a circle. FIG. 7 illustrates that the new position should be the intersection of the two circles whose center points are (0, 0) and (D, 0), and radii are D_{1,1} and D_{1,2}, respectively. FIGS. 8A-8C show the raw Doppler shift measurements and the result after Maximal Ratio Combining (MRC) without and with outlier removal, respectively. FIG. 9 is a flowchart of a method for controlling an electronic device containing a single speaker.

In order to enable mobile device 103 to function as a motion-based controller (e.g., mouse), the device movement should be tracked very accurately, within a few centimeters. Existing indoor localization that provides meter-level accuracy cannot achieve this goal. Many smart TV and set-top box manufacturers provide advanced remote controllers. Some of them even provide motion control and gesture recognition using inertial sensors, such as accelerometers and gyroscopes. Existing accelerometers are well-known for their significant measurement errors and cannot provide accurate tracking. Gyroscopes achieve better accuracy in tracking rotation. However, a user has to learn how to rotate in order to control the displacement in a 2-D space. This is not intuitive, and is especially hard for moving in a diagonal direction, thereby degrading user experience and speed of control.

As discussed herein, the present invention enables a mobile device 103 (FIGS. 1 and 2) to accurately track device movement in real time. It enables any mobile device with a microphone, such as a smartphone and a smart watch, to serve as a motion-based controller (e.g., mouse) to control an electronic device with speakers. A unique feature of the approach of the present invention is that it uses existing hardware in mobile and electronic devices.

A brief discussion of the overall approach is as follows. Referring to FIG. 1, device 101 emits inaudible acoustic signals, and mobile device 103 records and sends it back to device 101, which estimates the device position based on the Doppler shift.

While there are some existing work that leverages the Doppler shift for gesture recognition, tracking is more challenging since gesture recognition only requires matching against one of the training patterns, whereas, tracking requires accurate positioning of the mobile device. This not only requires an accurate estimation of the frequency shift, but also translating the frequency shift into a position that involves significant additional research issues, such as how to estimate the distance between the speakers, the device's initial device position, and its new position based on the frequency shift.

These challenging issues are addressed in the following way. The frequency shift is estimated and used to position mobile device 103 assuming that the distance between the speakers 102A, 102B and mobile device's 103 initial position are both known. Then techniques are developed to quickly calibrate the distance between the speakers 102A, 102B using the Doppler shift. To address mobile device's 103 unknown initial position, a particle filter is employed, which generates many particles corresponding to mobile device's 103 possible positions and filters the particles whose locations are inconsistent with the measured frequency shifts. The current position of mobile device 103 is estimated as the centroid of the remaining particles. To further enhance robustness, signals are transmitted at multiple frequencies, outlier removal is performed, and the remaining estimations are combined. Finally, the approach of the present invention is generalized to handle the equipment that has only one speaker along with another wireless device (e.g., Wi-Fi). In this case, the frequency shift from the inaudible acoustic signal and the phase of the received Wi-Fi signal are used to derive the distance of mobile device 103 from the speaker and Wi-Fi transmitter. The same framework is applied to continuously track mobile device 103 in real time as before.

As stated above, FIG. 3 is a flowchart of a method 300 for utilizing mobile device 103 (FIG. 1) as a motion-based controller (e.g., mouse) to communicate with device 101 (FIG. 1), such as a smart TV, in accordance with an embodiment of the present invention.

Referring to FIG. 3, in conjunction with FIGS. 1-2, in step 301, mobile device 103 determines a distance between speakers 102A, 102B of device 101. In one embodiment, such a distance may be calibrated by having a user of mobile device 103 move mobile device 103 back and forth across device 101 as discussed further below.

In one embodiment, the distance between speakers 102A, 102B is known a priori. In practice, this information may not be available in advance. One solution is to ask the user to measure the distance between speakers 102A, 102B using a ruler and report it. This is troublesome. Moreover, sometimes users do not know the exact location of speakers 102A, 102B. Therefore, it is desirable to provide a simple yet effective calibration mechanism that measures the speaker distance whenever the speakers' positions change.

A Doppler based calibration method is proposed herein. It only takes a few seconds for a user to conduct calibration. As shown in FIG. 4A, FIG. 4A illustrates a user scanning device 101 with the user's hand holding mobile device 103 during the calibration process in accordance with an embodiment of the present invention. During the calibration, device 101 emits inaudible sounds and mobile device 103 records it using its microphone 210 (discussed below in connection with steps 303, 304). In one embodiment, during calibration, the user starts from the left end of device 101, and move towards the right end of device 101 in a straight line. The user stops after it moves beyond the right end, and comes back to the left end. The user can repeat this procedure a few times to improve the accuracy.

FIG. 4B shows the change of the Doppler shift while a user is performing the calibration in accordance with an embodiment of the present invention. The time when mobile device 103 moves past the left and right speakers 102A, 102B can be detected, and the distance between speakers 102A, 102B can be measured by calculating the movement speed based on the Doppler shift. The Doppler shift is positive as the receiver moves towards the sender. When mobile device 103 is at the left side of both speakers 102A, 102B, both F₁^{S} (the amount of frequency shift from the first speaker, such as speaker 102A) and F₂^{S} (the amount of frequency shift from the second speaker, such as speaker 102B) are positive as it moves towards the right. As it passes the left speaker at 1.48 second (as shown in FIG. 4A), F₁^{S} changes to negative while F₂^{S} stays positive. Similarly, as mobile device 103 passes the right speaker, F₂^{S} changes from positive to negative. By finding these points, one finds the amount of time user spends moving between the two speakers 102A, 102B thereby measuring the distance between speakers 102A, 102B using the Doppler shift. To improve the accuracy, an estimate of the distance in each direction is obtained and then the estimated distances in both directions are averaged.

In particular, FIGS. 4A and 4B illustrate measuring the distance between speakers 102A, 102B by estimating T₁ and T₂ (i.e., the time it gets closest to the left and right speakers, respectively) and the speed during T₁ and T₂ using the Doppler shift. Dots 401, 402 in FIG. 4B represent T₁ and T₂, where T₁=1.48 seconds and T₂=3.58 seconds.

One question is how many repetitions are required to achieve reasonable accuracy. It depends on the distance error and its impact on device tracking. When users repeat the calibration three times (i.e., moving mobile device 103 back and forth for three times), the 95 percentile error is 5 cm. The experiment also shows the impact of a 5 cm speaker distance error on device tracking is negligible. Therefore, three repetitions are generally sufficient.

In the case where the initial position of mobile device 103 is unknown, in step 302, mobile device 103 generates particles corresponding to possible initial locations of mobile device 103. As will be discussed in greater detail below, those particles whose locations are inconsistent with the estimated frequency shift will be filtered and the current position of mobile device 103 will then be estimated using a centroid of the remaining particles not filtered.

In step 303, mobile device 103 receives inaudible signals from device 101 that contains two speakers 102A, 102B. In one embodiment, speakers 102A, 102B are generating inaudible acoustic signals at different frequencies.

In step 304, mobile device 103 records the received inaudible acoustic signals.

In step 305, mobile device 103 sends the recorded inaudible acoustic signals to device 101 to perform the steps (e.g., steps 306-311) discussed below. Alternatively, mobile device 103 performs the following steps as discussed below.

In step 306, mobile device 103 estimates the frequency shift using the recorded inaudible acoustic signals as discussed in further detail below.

In step 307, mobile device 103 estimates the velocity of mobile device 103 using the estimated frequency shift as discussed further below.

The Doppler effect is a well-known phenomenon where the frequency of a signal changes as a sender or receiver moves. Without loss of generality, the case that only the receiver moves while the sender remains static is considered. Let F denote the original frequency of the signal, F^{S} denote the amount of frequency shift, and v and c denote the receiver's speed towards the sender and the propagation speed of wave, respectively. They have the following relationship:

v=(F^{S}/F)*c EQ(1)

So if F and c are known and F^{S} can be measured, then EQ(1) can be used to estimate the speed of movement. Compared to the acceleration that requires double integration to get the distance, the Doppler shift allows us to get distance using a single integration, which is more reliable.

The Doppler effect is observed in any wave, including RF and acoustic signals. The acoustic signal is used to achieve high accuracy due to its (i) narrower bandwidth and (ii) slower propagation speed. Its narrower bandwidth makes it easy to detect a 1 Hz frequency shift than that in RF signals (e.g., 44.1 KHz in acoustic signals versus 20 MHz in Wi-Fi). Even assuming that one can detect a 1 Hz frequency shift in both Wi-Fi and acoustic signals, the accuracy in speed estimation is still higher in the acoustic signal due to its slower speed. The acoustic signal travels at 346 m/s in dry air at 26° C. If one uses the sound frequency of 17 KHz, the speed resolution is 1*346.6/17000=0.02 m/s=2 cm/s. In comparison, when the RF center frequency is 2.4 GHz, the resolution is 1*3*10̂8/(2.4*10̂9)=0.125 m/s=12.5 cm/s, which is around 6 times as large. This implies that for the same movement, the Doppler shift of the acoustic signal is six (6) times that of the RF signal, which allows one to more accurately measure the movement speed.

Moreover, the acoustic signal can be easily generated and received using speakers and microphones, which are widely available on TVs, Google Glasses®, smartphones, and smart watches. To avoid disturbance to other people, inaudible acoustic signals can be generated. While in theory some people may hear up to 20 KHz, is was found that sound above 17 KHz is typically inaudible.

As discussed herein, a simple experiment is performed to see how accurately one can track the movement of mobile device 103 using the Doppler shift. Using MATLAB®, a 17 KHz sinusoid audio file is generated that takes 1 Hz in the frequency domain, and played it using a normal PC speaker, and recorded it using a microphone on Google® NEXUS® 4. The Doppler shift was measured while mobile device 103 is moving towards a speaker 102A, 102B of device 101. The details on how to accurately calculate the Doppler shift will be explained below. FIGS. 5A and 5B show the Doppler shift and the moving distance over time estimated by Equation EQ1, respectively, in accordance with an embodiment of the present invention. As illustrated in FIG. 5B, the tracking error is less than 1 cm. Mobile device 103 starts moving at 1 second and stops at 2.8 seconds. Dots 501A, 501B of FIG. 5A represent and start and end of the movement, respectively. Unlike acceleration measurement, it is easy to tell the start and stop time of movement of mobile device 103 (e.g., the Doppler shift is well above 1 Hz during movement and well below 1 Hz when it stops). Moreover, since one can get speed from the Doppler shift and can calculate the distance traveled using a single integration rather than double integrations in accelerometer, the accuracy improves significantly. As shown in FIG. 5B, the maximum tracking error is only 0.7 cm.

Based on the above concept, the following system, as illustrated in FIG. 1 was developed, where a sender (e.g., device 101) with two speakers 102A, 102B sends inaudible sound pulses to a mobile device 103 to be tracked. As discussed above, mobile device 103 can be any device with a microphone, such as a smartphone and smart watch. To distinguish which speaker 102A, 102B generates the signal, the two speakers 102A, 102B emit different frequencies. In one embodiment, mobile device 103 initiates tracking using a simple gesture or tapping the screen, and starts recording the audio signal from microphone 210. Mobile device 103 can either locally process the received signal to compute its location, or send the received audio file via a wireless interface (e.g., Wi-Fi or Bluetooth) back to the sender 101 for it to process the data and track mobile device 103. The audio signal is simply a sequence of pulse-coded modulation (PCM) bits, which is typically 16 bits per sample. Assuming 44.1 KHz sampling rate, the amount of the audio data per second is 705.6 Kb, which is lower than the bit-rate of classic Bluetooth (i.e., 2.1 Mbps). Depending on the application, it can be translated into the cursor position or used to track the trajectory of the user's movement.

To record sound in inaudible range (e.g., between 17 KHz and 22 KHz) without aliasing, one could use the audio sampling rate of at least 44 KHz. To achieve high tracking accuracy, the aim is to estimate frequency shift with a resolution of 1 Hz. This implies one needs to perform 44,100-point FFT to analyze the signal in the frequency domain in 1 Hz-level. This poses a challenge: a long FFT does not allow us to continuously track a device in real time. For 44,100-point FFT, one would need to store 44,100 samples, which takes one second. During that time, the device's position might already have changed several times, which significantly degrades the reliability and responsiveness of tracking.

To address this issue, Short-Term Fourier Transform (STFT) is used to analyze the change of spectrum over time. It uses fewer data samples than that required by FFT. The missing values of the input are filled with zeros. Then the FFT output has desired resolution. However, this alone may cause aliasing due to under-sampling. To minimize the distortion, windowing is applied in the time domain and each window contains all the audio samples during the current sampling interval. In one embodiment, a Hanning window is used for that purpose. The principles of the present invention are not to be limited in scope to using the Hanning function and may use other functions to accomplish the same purpose.

In the design of the present invention, the input length is set to 44,100 and 1,764 audio samples (i.e., the total number of audio samples in 40 ms) are used as the input, which gives the FFT output with 1 Hz resolution every 40 ms. From it, the Doppler shift is measured by finding the peak frequency (i.e., the frequency with the highest value) and subtracting it from the original signal frequency. The complexity is determined by the width of spectrum to be scanned in order to detect the peak frequency. It was set to 100 Hz assuming that the maximum possible Doppler shift is 50 Hz, which corresponds to 1 m/s. According to the experiment of the present invention, when a person moves a mobile device 103 with his/her hand, its speed does not exceed 1 m/s. FIGS. 6A and 6B show an example of the received audio signal in the frequency domain and the estimated Doppler shift, respectively, while mobile device 103 (FIGS. 1 and 2) is moving around a circle in accordance with an embodiment of the present invention.

In step 308, mobile device 103 estimates the distance mobile device 103 is from each speaker 102A, 102B using the estimated velocity and the previous position of each particle (previous position of mobile device 103). In one embodiment, as discussed further below, based on the arrival time of the audio signal from each of the speakers 102A, 102B to a microphone, one can measure the difference in the propagation delay of the sound, which is used to estimate the difference in the distance from each of the speakers 102A, 102B. This relative distance can be combined with the distance estimation from the frequency shift using the particle filter (discussed further below) to further enhance the accuracy. Such a step is optional, but helps to improve the accuracy.

In step 309, mobile device 101 determines the current location of each particle using estimated distances mobile device 103 is located from speakers 102A, 102B, the distance between speakers 102A, 102B and a previous position of each particle (previous position of mobile device 103).

In step 310, mobile device 103 filters particles whose locations are inconsistent with the estimated velocity.

In step 311, mobile device 103 estimates the current position of mobile device 103 using a centroid of the remaining particles not filtered as discussed below.

After the current location of mobile device 103 is determined, further inaudible signals are received from device 101 in step 303 to determine the next location of mobile device 103 as mobile device 103 is moved.

There are times when the initial position of mobile device 103 is unknown. To address this, a particle filter is used. Particle filters have been successfully used in localization to address the uncertainty of the location. The particle filter is utilized by the principles of the present invention in the following way. Initially, many particles are uniformly distributed in an area, where each particle corresponds to a possible initial position of mobile device 103. In the next Doppler sampling interval, it determines the movement of mobile device 103 from the current particles. If the movement of mobile device 103 is not feasible, the particle is filtered out. As will be discussed further below, the position of the device is determined by finding the intersection of the two circles. If D+D₂≦D (where D refers to the distance between speakers 102A, 102B as discussed further below, D₁ is the distance from the first speaker (e.g., speaker 102A) and the location of mobile device 103 and D₂ is the distance from the second speaker (e.g., speaker 102B) and the location of mobile device 103) one can find one or more intersections; otherwise, there is no intersection. In this case, the current particle is regarded as infeasible and filters it out. The movement of mobile device 103 is determined by averaging the movement of the all remaining particles.

More specifically, let P be the set of particles, which is initialized as P={(xₒ¹, yₒ¹), . . . , (xₒ^{N}, yₒ^{N})}, where (xₒ^{k}, yₒ^{k}) is the initial position of the k-th particle and N is the number of particles. During a new Doppler sampling interval, the particles that give infeasible movement are filtered out from P. After the i-th movement, the position at the i+1th sample is tracked by averaging the difference between the (i+1)th and i-th particle positions. That is,

$$( {x}_{i + 1} , {y}_{i + 1} ) = ( {x}_{i} + {\sum }_{k ∈ P} \frac{( {x}_{i + 1}^{k} - {x}_{i}^{k} )}{\vert P \vert} , {y}_{i} + {\sum }_{k ∈ P} \frac{( {y}_{i + 1}^{k} - {y}_{i}^{k} )}{\vert P \vert} ) ,$$

where |P| is the number of remaining particles in P.

The question remains how many particles to allocate. There is a trade-off between complexity and accuracy. Increasing the number of particles is likely to increase the accuracy of initial position estimation. In one embodiment, 625 particles were used to balance the trade-off 625 particles take 3.63 ms to process, well below the 40 ms sampling interval.

As discussed further herein, the estimated frequency shift is used to derive the position of mobile device 103. The distance between the speakers 102A, 102B of device 101 is obtained through the above calibration step and the previous position of mobile device 103 is estimated as the centroid of the remaining particles. It is now considered how to obtain the new position of the mobile device based on the distance between the speakers, the previous position of the mobile device, and the estimated frequency shift.

The frequency shift from speakers 102A, 102B is estimated to get the distance change from the speakers. More specifically, let D denote the distance between speakers 102A, 102B. A virtual two-dimensional coordinate is constructed where the origin is the left speaker and the X-axis is aligned with the line between speakers 102A, 102B. In this coordinate, the left and right speakers are located at (0, 0) and (D, 0), respectively. Let (x₀, y₀) denote the mobile device's 103 previous position in this coordinate. The distances from mobile device 103 to the speakers 102A, 102B are denoted by D_{1,1} and D_{1,2}, respectively. Let tₛ be the sampling interval in which the frequency shift is estimated. In one embodiment, the present invention utilized 40 ms, which means the cursor's position is updated every 40 ms, which corresponds to popular video frame rates of 24-25 frames per second. After tₛ, one can obtain the new distance from the two speakers 102A, 102B using the Doppler shift. From the measured Doppler shift and Equation EQ(1), one obtains:

D_{1,1}=D_{0,1}+({F_{1,1}^{s}/F₁}c)tₛ,

D_{1,2}=D_{0,2}+({F_{1,2}^{s}/F₂}c)tₛ,

where Fₖ and F_{i,k}^{s} are the sound frequency and Doppler shift from speaker k during the i-th sampling interval, respectively.

Given the updated distance from speakers 102A, 102B, the remaining question is how to get the new position. As illustrated in FIG. 7, the new position should be the intersection of the two circles whose center points are (0, 0) and (D, 0), and radii are D_{1, 1} and D_{1, 2}, respectively, in accordance with an embodiment of the present invention. The intersection of the two circles can be efficiently calculated as follows:

$${θ}_{i} = {cos}^{- 1} ( \frac{{D}_{1 , 1}^{2} + {D}^{2} - {D}_{1 , 2}^{2}}{2 {DD}_{1 , 1}} ) , \\ ( {x}^{1} , {y}^{1} ) = ( {D}_{1 , 1} cos ( {θ}_{1} ) , {D}_{1 , 1} sin ( {θ}_{1} ) ) , \\ ( {x}^{2} , {y}^{2} ) = ( {D}_{1 , 1} cos ( - {θ}_{1} ) , {D}_{1 , 1} sin ( - {θ}_{1} ) ) ,$$

where (x¹, y¹) and (x², y²) are two intersection points of the circles. Note that if D_{t,1}+D_{t,2}<D, there is no intersection between the two circles. If D_{t,1}+Dₜ₂=D, there is one intersection. In the other cases, there are two intersection points. In the last case, the point closer to (x₀,y₀) was chosen as the next position, denoted as (x₁, y₁), since the movement is continuous and the sampling interval is small.

In the next Doppler sampling interval, one measures F_{2,1}^{s} and F_{2,2}^{s}, calculate D_{2,1} and D_{2,2}, and derive (x₂,y₂) from it. This process is repeated until mobile device 103 stops moving. To minimize the impact of errors in the frequency shift estimation, the frequency shift below 1 Hz is filtered and the remaining frequency shifts are used to estimate the speeds and distance.

To achieve high accuracy in device tracking, it is important to accurately estimate the Doppler shift. However, measuring it from a single sound wave may not be reliable. The accuracy of estimating the Doppler shift in part depends on the signal-to-noise ratio (SNR) of the received signal. Due to frequency selective fading, SNR varies across frequencies. To enhance robustness, in one embodiment, 1-Hz sound tones are sent at different center frequencies, and all of them are used to measure the Doppler shift.

In order to leverage multiple frequencies, the first question is which center frequencies should be used. If the different center frequencies are too close, they will interfere with each other especially under movement. As mentioned earlier, the hand movement speed for mouse applications is typically within 1 m/s, which corresponds to a 50 Hz Doppler shift. To be conservative, adjacent sound tones are set to be 200 Hz apart. In one embodiment, 10 sound tones are allocated for each speaker 102A, 102B.

The next question is how to take advantage of the measurements at multiple frequencies to improve the accuracy. One approach is to apply the Maximal Ratio Combining (MRC) technique used in the receiver antenna diversity, which averages the received signal weighted by the inverse of the noise variance. It is known to be optimal when the noise follows a Gaussian distribution. However, some frequencies may incur significantly higher noise than others, and it is important to remove such outliers before combining them using a weighted average. In the system of the present invention, the Doppler sampling interval is 40 ms. 10 Hz difference from the previous measurement implies that the velocity has changed 0.2 m/s during 40 ms, which translates into an acceleration of 5 m/s². Such a large acceleration is unlikely to be caused by the movement of mobile device 103. So whenever the change in frequency shifts during two consecutive sampling intervals (e.g., |F_{1+1,k}^{s}−F_{1,k}^{s}|) is larger than 10 Hz, it is considered to be an error and removed before performing MRC. In an exceptional case where all the measurement differences exceed 10 Hz, the one closest to the previous measurement is selected. After MRC, the Kalman filtering is applied to smooth the estimation. The process noise covariance Q and measurement noise covariance R in the Kalman filter are both set to 0.00001.

FIGS. 8A-8C show the raw Doppler shift measurements and the result after MRC without and with outlier removal, respectively, in accordance with an embodiment of the present invention. In particular, FIG. 8A illustrates the Doppler shift measured from 5 tones. FIG. 8B illustrates the Doppler shift after MRC without outlier removal. FIG. 8C illustrates the Doppler shift after MRC with outlier removal. It shows that the Doppler estimation after outlier removal yields more smooth output and likely contains smaller errors.

The foregoing has discussed controlling device 101 that contains two speakers 102A, 102B so that one can estimate the distance from these speakers 102A, 102B to track mobile device 103. Currently, smart TVs have two speakers. Most laptops have two speakers. Some recent laptops have three speakers to offer better multimedia experience. Three speakers provide more anchor points and allow one to track in a 3-D space or further improve tracking accuracy in a 2-D space.

However, device 101 may only contain a single speaker. A method for controlling an electronic device 101 that contains a single speaker is discussed below in connection with FIG. 9.

FIG. 9 is a flowchart of a method 900 for controlling an electronic device 101 containing a single speaker (e.g., device 101 only contains speaker 102A or only contains speaker 102B) in accordance with an embodiment of the present invention.

It is noted that many of the steps of method 900 correspond to the steps of method 300 and therefore will not be discussed in detail for the sake of brevity.

Referring to FIG. 9, in conjunction with FIGS. 1-3, in step 901, mobile device 103 determines the distance between a speaker (e.g., speaker 102A) of device 101 and a wireless transmitter of wireless device 104.

In step 902, mobile device 103 generates particles corresponding to possible locations of mobile device 103.

In step 903, mobile device 103 receives an inaudible signal from device 101 that contains a single speaker.

In step 904, mobile device 103 receives a radio frequency signal (e.g., Wi-Fi signal, a Bluetooth signal, a wireless signal) from a wireless device 104.

In step 905, mobile device 103 records the received inaudible signal and radio frequency signal.

In step 906, mobile device 103 sends the record inaudible signal and radio frequency signal to device 101 to be controlled to perform the steps (e.g., steps 906-914) discussed below. Alternatively, mobile device 103 performs the following steps as discussed below.

In step 907, mobile device 103 estimates a phase of the radio frequency signal.

In step 908, mobile device 103 estimates the distance mobile device 103 is located from the wireless transmitter of wireless device 104 using the estimated phase of the radio frequency signal and a previous position of mobile device 103.

In step 909, mobile device 103 estimates the frequency shift using the recorded inaudible signal and estimated phase of the radio frequency signal.

In step 910, mobile device 103 estimates the velocity of mobile device 103 from the speaker using the estimated frequency shift and estimates the velocity of mobile device 103 from a wireless transmitter of wireless device 104 using the estimated phase of the radio frequency signal.

In step 911, mobile device 103 estimates the distance mobile device 103 is located from the speaker and the wireless transmitter based on the velocities of mobile device 103 and the previous position of each particle (previous position of mobile device 103).

In the case where the initial position of mobile device 103 is unknown, in step 910, mobile device 103 determines the current location of each particle using the estimated distances mobile device 103 is located from the single speaker (e.g., speaker 102A) of device 101 and the wireless transmitter of wireless device 104, the distance between the speaker (e.g., speaker 102A) and the wireless transmitter of wireless device 104 and the previous position of each particle (previous position of mobile device 103).

In step 913, mobile device 103 filters particles whose locations are inconsistent with the estimated velocity.

In step 914, mobile device 103 estimates the current position of mobile device 103 using a centroid of the remaining particles not filtered.

After the current location of mobile device 103 is determined, further inaudible signals are received from device 101 in step 903 to determine the next location of mobile device 103 as mobile device 103 is moved.

While the foregoing discusses the present invention in connection with utilizing electronic device 101 with a single speaker along with wireless device 104, the principles of the present invention may utilize electronic device 101 with two or more speakers (e.g., speakers 102A, 102B) along with wireless device 104 using the methodology as discussed above in connection with FIG. 3. For example, the estimated velocity of mobile device 103 would then be determined using the estimated frequency shift along with using the phase of the received radio frequency signal.

So far it has been assumed that the equipment to be controlled has two speakers 102A, 102B so that one can estimate the distance from these speakers 102A, 102B to track mobile device 103. Currently, smart TVs have two speakers. Most laptops have two speakers. Some recent laptops have three speakers to offer better multimedia experience. Three speakers provide more anchor points and allow one to track in a 3-D space or further improve tracking accuracy in a 2-D space.

As discussed herein, the approach of the present invention may be extended to handle devices 101 that have only one speaker. In such a scenario, it is assumed that system 100 has another wireless device 104. The Doppler effect of the acoustic signal from the speaker can then be used along with the RF signal from wireless device 104 to enable tracking.

The same framework as described above is used for tracking. The new issue is how to estimate the distance between mobile device 103 and wireless device 104 on the equipment. The following known relationship is used to compute the distance:

Øₜ₁=−mod(2π/λdₜ₁,2π)

Øₜ₂=−mod(2π/λdₜ₂,2π)

where Øₜ₁ and Øₜ₂ denote the phase of the received signal at the mobile device 103 at time t1 and t2, respectively, and dₜ₁ and dₜ₂ are their respective distances. This enables one to track the new distance from the RF source by

dₜ₂=((Øₜ₂−Øₜ₁)/2π+k)λ+dₜ₁, (EQ 2)

where k is an integer and set to 0 since the sampling interval of the RF phase is 10 ms and it is safe to assume that movement is less than one wavelength during a sampling interval.

One of the challenges in RF phase based tracking is accurate measurement of the received signal phase. In particular, the carrier frequency offset (CFO) between the sender and the receiver causes the phase to change over time even if the receiver is not moving. In one embodiment, to simplify the implementation, a sender and a receiver are connected with the same external clock to guarantee that they have no frequency offset. The phase of the receiver is estimated while the sender is continuously sending 1 MHz wide orthogonal frequency-division multiplexing (OFDM) symbols.

As previously discussed, if one knows the mobile device's 103 initial location and the distance between the speaker and RF source, one can track the position by finding the intersections of the two circles whose radii are the distance measured by the Doppler shift and RF phase tracking, respectively. Furthermore, one can again apply the particle filter to address the issue when the initial position of mobile device 103 is unknown. Additionally, similar calibration methods can be adopted to measure the distance between the speaker and RF source by detecting the speaker's position based on the change in the sign of the Doppler shift (e.g., going from positive to negative) and detecting the RF source's position based on the change in the phase of the received RF signal (e.g., going from decreasing phase to increasing phase).

As discussed herein, a novel system that can accurately track hand movement and apply it to realize a mouse is developed. A unique advantage of the scheme of the present invention is that it achieves high tracking accuracy (e.g., median error of around 1.4 cm) using the existing hardware already available in the mobile devices and equipment to be controlled (e.g., smart TVs).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for utilizing a mobile device as a motion-based controller, the method comprising:
determining a distance between two or more speakers of a device to be controlled by said mobile device;
receiving inaudible acoustic signals by said mobile device with a microphone from said device;
recording said inaudible acoustic signals;
estimating a frequency shift using said recorded inaudible acoustic signals;
estimating a velocity of said mobile device using said estimated frequency shift;
estimating distances said mobile device is located from each of said two or more speakers using said estimated velocity and a previous position of said mobile device; and
determining, by a processor, a current location of said mobile device using said estimated distances said mobile device is located from said two or more speakers, said distance between said two or more speakers of said device and said previous position of said mobile device.

2. The method as recited in claim 1, wherein said two or more speakers generate said inaudible acoustic signals at different frequencies.

3. The method as recited in claim 2 further comprising:
applying a maximal ratio combining technique to said inaudible acoustic signals at said different frequencies to remove outliers.

4. The method as recited in claim 1 further comprising:
calibrating said distance between said two or more speakers of said device.

5. The method as recited in claim 4, wherein said calibration comprises movement of said mobile device back and forth across said device.

6. The method as recited in claim 1 further comprising:
generating particles corresponding to possible initial locations of said mobile device; and
filtering said particles whose locations are inconsistent with said estimated velocity.

7. The method as recited in claim 6 further comprising:
estimating a current position of said mobile device using a centroid of remaining particles not filtered.

8. A method for utilizing a mobile device as a motion-based controller, the method comprising:
determining a distance between a speaker and a wireless transmitter of a wireless device;
receiving an inaudible acoustic signal by said mobile device with a microphone from a device with said speaker to be controlled by said mobile device;
receiving a radio frequency signal from said wireless device;
recording said inaudible acoustic signal and said radio frequency signal;
estimating a phase of said radio frequency signal;
estimating a distance said mobile device is located from said wireless transmitter using said estimated phase of said radio frequency signal and a previous position of said mobile device;
estimating a frequency shift using said recorded inaudible acoustic signal;
estimating a velocity of said mobile device from said speaker using said estimated frequency shift;
estimating a distance said mobile device is located from said speaker using said estimated velocity and said previous position of said mobile device; and
determining, by a processor, a current location of said mobile device using said estimated distance said mobile device is located from said speaker, said estimated distance said mobile device is located from said wireless transmitter, said distance between said speaker and said wireless transmitter of said wireless device and said previous position of said mobile device.

9. The method as recited in claim 8, wherein said radio frequency signal is a Wi-Fi signal, a Bluetooth signal or a wireless signal.

10. A method for utilizing a mobile device as a motion-based controller, the method comprising:
determining a distance between two or more speakers of a device to be controlled by said mobile device;
determining a distance between each of said two or more speakers of said device and a wireless transmitter of a wireless device;
receiving inaudible acoustic signals by said mobile device with a microphone from said device;
receiving a radio frequency signal from said wireless device;
recording said inaudible acoustic signals and said radio frequency signal;
estimating a phase of said radio frequency signal;
estimating a distance said mobile device is located from said wireless transmitter of said wireless device using said estimated phase of said radio frequency signal and a previous position of said mobile device;
estimating a frequency shift using said recorded inaudible acoustic signals;
estimating a velocity of said mobile device towards each of said two or more speakers using said estimated frequency shift;
estimating distances said mobile device is located from each of said two or more speakers using said estimated velocity and said previous position of said mobile device; and
determining, by a processor, a current location of said mobile device using said estimated distances said mobile device is located from each of said two or more speakers, said estimated distance said mobile device is located from said wireless transmitter of said wireless device, said distance between said two or more speakers of said device, said distance between each of said two or more speakers of said device and said wireless transmitter of said wireless device and said previous position of said mobile device.

11. The method as recited in claim 10, wherein said radio frequency signal is a Wi-Fi signal, a Bluetooth signal or a wireless signal.

12. A computer program product for utilizing a mobile device as a motion-based controller, the computer program product comprising a computer readable storage medium having program code embodied therewith, the program code comprising the programming instructions for:
determining a distance between two or more speakers of a device to be controlled by said mobile device;
receiving inaudible acoustic signals by said mobile device with a microphone from said device;
recording said inaudible acoustic signals;
estimating a frequency shift using said recorded inaudible acoustic signals;
estimating a velocity of said mobile device using said estimated frequency shift;
estimating distances said mobile device is located from each of said two or more speakers using said estimated velocity and a previous position of said mobile device; and
determining a current location of said mobile device using said estimated distances said mobile device is located from said two or more speakers, said distance between said two or more speakers of said device and said previous position of said mobile device.

13. The computer program product as recited in claim 12, wherein said two or more speakers generate said inaudible acoustic signals at different frequencies.

14. The computer program product as recited in claim 13, wherein the program code further comprises the programming instructions for:
applying a maximal ratio combining technique to said inaudible acoustic signals at said different frequencies to remove outliers.

15. The computer program product as recited in claim 12, wherein the program code further comprises the programming instructions for:
calibrating said distance between said two or more speakers of said device.

16. The computer program product as recited in claim 15, wherein said calibration comprises movement of said mobile device back and forth across said device.

17. The computer program product as recited in claim 12, wherein the program code further comprises the programming instructions for:
generating particles corresponding to possible initial locations of said mobile device; and
filtering said particles whose locations are inconsistent with said estimated velocity.

18. The computer program product as recited in claim 17, wherein the program code further comprises the programming instructions for:
estimating a current position of said mobile device using a centroid of remaining particles not filtered.

19. A computer program product for utilizing a mobile device as a motion-based controller, the computer program product comprising a computer readable storage medium having program code embodied therewith, the program code comprising the programming instructions for:
determining a distance between a speaker and a wireless transmitter of a wireless device;
receiving an inaudible acoustic signal by said mobile device with a microphone from a device with said speaker to be controlled by said mobile device;
receiving a radio frequency signal from said wireless device;
recording said inaudible acoustic signal and said radio frequency signal;
estimating a phase of said radio frequency signal;
estimating a distance said mobile device is located from said wireless transmitter using said estimated phase of said radio frequency signal and a previous position of said mobile device;
estimating a frequency shift using said recorded inaudible acoustic signal;
estimating a velocity of said mobile device from said speaker using said estimated frequency shift;
estimating a distance said mobile device is located from said speaker using said estimated velocity and said previous position of said mobile device; and
determining a current location of said mobile device using said estimated distance said mobile device is located from said speaker, said estimated distance said mobile device is located from said wireless transmitter, said distance between said speaker and said wireless transmitter of said wireless device and said previous position of said mobile device.

20. The computer program product as recited in claim 19, wherein said radio frequency signal is a Wi-Fi signal, a Bluetooth signal or a wireless signal.

21. A mobile device, comprising:
a memory unit for storing a computer program for utilizing said mobile device as a motion-based controller; and
a processor coupled to the memory unit, wherein the processor is configured to execute the program instructions of the computer program comprising:
determining a distance between two or more speakers of a device to be controlled by said mobile device;
receiving inaudible acoustic signals by said mobile device with a microphone from said device;
recording said inaudible acoustic signals;
estimating a frequency shift using said recorded inaudible acoustic signals;
estimating a velocity of said mobile device using said estimated frequency shift;
estimating distances said mobile device is located from each of said two or more speakers using said estimated velocity and a previous position of said mobile device; and
determining a current location of said mobile device using said estimated distances said mobile device is located from said two or more speakers, said distance between said two or more speakers of said device and said previous position of said mobile device.

22. The mobile device as recited in claim 21, wherein said two or more speakers generate said inaudible acoustic signals at different frequencies.

23. The mobile device as recited in claim 22, wherein the program instructions of the computer program further comprise:
applying a maximal ratio combining technique to said inaudible acoustic signals at said different frequencies to remove outliers.

24. The mobile device as recited in claim 21, wherein the program instructions of the computer program further comprise:
calibrating said distance between said two or more speakers of said device.

25. The mobile device as recited in claim 24, wherein said calibration comprises movement of said mobile device back and forth across said device.

26. The mobile device as recited in claim 21, wherein the program instructions of the computer program further comprise:
generating particles corresponding to possible initial locations of said mobile device; and
filtering said particles whose locations are inconsistent with said estimated velocity.

27. The mobile device as recited in claim 26, wherein the program instructions of the computer program further comprise:
estimating a current position of said mobile device using a centroid of remaining particles not filtered.

28. A mobile device, comprising:
a memory unit for storing a computer program for utilizing said mobile device as a motion-based controller; and
a processor coupled to the memory unit, wherein the processor is configured to execute the program instructions of the computer program comprising:
determining a distance between a speaker and a wireless transmitter of a wireless device;
receiving an inaudible acoustic signal by said mobile device with a microphone from a device with said speaker to be controlled by said mobile device;
receiving a radio frequency signal from said wireless device;
recording said inaudible acoustic signal and said radio frequency signal;
estimating a phase of said radio frequency signal;
estimating a distance said mobile device is located from said wireless transmitter using said estimated phase of said radio frequency signal and a previous position of said mobile device;
estimating a frequency shift using said recorded inaudible acoustic signal;
estimating a velocity of said mobile device from said speaker using said estimated frequency shift;
estimating a distance said mobile device is located from said speaker using said estimated velocity and said previous position of said mobile device; and
determining a current location of said mobile device using said estimated distance said mobile device is located from said speaker, said estimated distance said mobile device is located from said wireless transmitter, said distance between said speaker and said wireless transmitter of said wireless device and said previous position of said mobile device.

29. The mobile device as recited in claim 28, wherein said radio frequency signal is a Wi-Fi signal, a Bluetooth signal or a wireless signal.
